(19) United States
(12) Patent Application Publication
(10) Pub. No.: US 2002/0034679 A1
(43) Pub. Date: Mar. 21, 2002

(54) Gas-evolving electrochemical cells

(76) Inventors: Alexander M. Iarochenko, Toronto (CA); Evgeny B. Kulakov, Toronto (CA)

Correspondence Address: MANELLI DENISON & SELTER, 2000 M STREET NW SUITE 700, WASHINGTON, DC, 20036-3307, US

(21) Appl. No.: 09/935,753

(22) Filed: Aug. 24, 2001

(30) Foreign Application Priority Data
Sep. 21, 2000 (CA) 2,320,596
Mar. 19, 2001 (CA) 2,341,055

(51) Int. Cl. H01M 2/38; H01M 4/42; H01M 4/38

(52) U.S. Cl. 429/81; 429/229; 429/231.6

(57) ABSTRACT

An electrochemical battery comprising a housing; an electrolyte within the housing; an anode within the electrolyte and the housing and having an anode surface upper portion and an anode surface lower portion; a cathode within the electrolyte and the housing and having a cathode surface upper portion and a cathode surface lower portion at an inter-electrode distance from the anode to operably provide upward laminar flow of the electrolyte from the anode and cathode lower portions to the anode and cathode upper portions; recycle downcomer channel means for effecting and allowing of downward gravity flow of an upper portion of the electrolyte from the anode and cathode surface upper portions to provide a recycled lower portion of the electrolyte for recycle to the anode and cathode. The battery structure provides improved cell power performance, reduces unwanted temperature gradients in the cell, provides uniformity of electrolyte concentration and reduces cell passivation.

### FIELD OF THE INVENTION

This invention relates to gas-evolving electrochemical cells and batteries, particularly to metal anode and gas-diffusion cathode batteries, and more particularly to aluminum alloy anode and air-diffusion cathode batteries that generate hydrogen gas and increase in electrolyte temperature; and to a battery stack comprising a plurality of said batteries.

### BACKGROUND OF THE INVENTION

Batteries having a metal anode and gas diffusion cathode are known generally as metal air batteries. There are several reasons why metal air batteries work more efficiently if they are provided with electrolyte circulation. The most commonly cited reasons include increase of power output by means of increasing the flow of electrolyte reactive species to and from the electrode surfaces, decreasing the heat buildup in a battery under load by means of conduction of the hot electrolyte to cooler sections of the battery or to external radiative coolers, providing for removal of byproduct solids from the battery by transporting the electrolyte to a solids removal device and, hence, preventing the battery from becoming clogged with solids. The following examples of the prior art show how existing technology has been used to provide for electrolyte circulation within a metal air battery.

U.S. Pat. Nos. 4,908,281 and 5,093,213 teach how a metal air battery may be provided with an external pump to provide electrolyte circulation. A series of manifolds is needed to direct the electrolyte flow to a plurality of individual cells. A check valve prevents reverse flow from the pump and an optional air-cooled heat exchanger is provided in the external circuit. The disadvantage of this technology is that the external pump requires power and increases the cost of the system. Valves and manifolds of the system introduce complexity and increase potential failures. Furthermore the pumping action must be designed for full load conditions and since the pump capacity is fixed and is constant regardless of whether the battery is under full load or under a very small load where pumping may not be required, the power consumption by the pump reduces useful cell output efficiency, considerably.

U.S. Pat. No. 5,582,929 teaches electrolyte circulation between two compartments by means of compressed air to provide cooling of hot electrolyte using external cooling in one of the compartments. This arrangement, while avoiding direct electrical pumping costs, has the complexity of two electrolyte holding tanks and the costs associated with the supply of compressed air.

U.S. Pat. No. 5,376,471 teaches how to provide electrolyte circulation in a metal air battery by means of convection. The advantage of the cell is that a large stagnant electrolyte reservoir beneath the cell allows the reaction byproduct, aluminum hydroxide in this case, to settle out from the electrolyte. As noted in this work, aluminum air cells which operate at high current density (>400 mA/cm² ) are subject to short service life because supersaturation of the electrolyte at high current density causes precipitation of aluminum hydroxide at the electrodes and results in passivation, unless active electrolyte management is used. This patent disclosure focuses on low current density cells (5-75 mA/cm² ) and solids are allowed to settle by gravity, so that the lack of an external pump is an advantage because there is less fluid turbulence. Sufficient space is allowed around the electrodes such that the spent electrolyte can randomly flow to a bottom sump reservoir. The cell configuration is cylindrical and does not produce an organized increased fluid flow circulation. The generation of fluid flow in the large stagnant electrolyte reservoir beneath the cell is not beneficial since the aluminum hydroxide product would be stirred up and recirculated to the cells. Furthermore, the convective passage of the electrolyte is to the upper surface of the large stagnant electrolyte reservoir beneath the cell. The reason is again to avoid disturbance of the stagnant reservoir which would inhibit aluminum hydroxide settling. Further, it is stated that the aluminum hydroxide is initially gel-like and requires time to crystallize which explains the need to prevent circulation of the stagnant reservoir.

U.S. Pat. No. 5,567,540 teaches how a metal air battery may be provided with an external pump to provide electrolyte circulation. The additional advantage with this system is that a sensor is provided to activate the pumping action. In this manner, the pump is only activated when needed by the cell. U.S. Pat. No. 5,567,540 also describes how the electrolyte may be advantageously filtered in the external pumped circuit. However, this battery still has the disadvantage of the added complexity of the pumping system and sensors and, although the pump is activated only when needed, the pumping consumes power and the pumping rate is fixed and does not match the load of the cell.

U.S. Pat. No. 4,507,367 describes internal electrolyte pumping by means of hydrogen gas pressure and teaches how a metal air cell having a gas producing reaction may be constructed in a hermetic manner to provide for a buildup of internal gas pressure to circulate electrolyte. It is clear that such a device has the disadvantage of having to be hermetically sealed.

### SUMMARY OF THE INVENTION

It is an object of the present invention to provide a number of significant advantages over this prior art.

By providing active downcomer channels for the spent electrolyte, the circulation essentially becomes equivalent to a pumped cell. The relatively high fluid velocities enhance the battery's power performance. The electrolyte induced pumping action is able to clear the electrolyte of hydrogen gas and of particulate matter from the electrodes by means of the upward flow of electrolyte. Both thermal and gas evolution hydrodynamic effects are synergistically combined to promote advantageous electrolyte fluid flow. This action is directly linked to the electrical load on the battery so that with greater loads there is more need for electrolyte circulation and this greater circulation is directly provided. Thus the battery according to the invention is not limited to low current density applications as with aforesaid U.S. Pat. No. 5,376,471.

Through the use of electrolyte gas bubble-free circulation chambers the battery provides electrolyte circulation which improves cell power performance, reduces unwanted temperature gradients within the cell, provides uniformity of electrolyte concentration and separates cell reaction byproducts and, thus, eliminates cell deposition. The electrolyte circulation requires no external power supply for this electrolyte pumping action. The battery avoids the cost and noise of an electrical pump and, therefore, optimizes the electrical output by avoiding electrical pumping costs. The electrolyte circulation chamber is a proportional pumping system in that, as the load increases and the need for electrolyte circulation increases, the battery provides more electrolyte flow pumping action.

The mechanism of the fluid circulation pumping action relies on providing a vertical density gradient in the electrolyte in the inter-electrode space which has a void fraction due to gas bubbles and a lower intrinsic density due to higher thermal temperatures at its upper regions. At the top of the cell, sufficient space is allowed to provide for gas release from the electrolyte and some cooling due to convection. This degassed electrolyte, which is also partially cooled, then returns to the bottom of the cell by means of the electrolyte circulation chamber. The density of the downward flowing electrolyte in the circulation chamber is enhanced by contact with the outer cell wall and by the solids entrained in the flowing electrolyte. At the bottom of the electrolyte circulation chamber the solids are either deposited or flushed to a settling chamber and the electrolyte recycled to the electrodes free of solids and in a cooled state.

We have found that this internally pumped electrolyte system, powered without the need for external pumping is very efficient in providing at times of high load, an electrolyte density difference that is greatest because of the heat released from the metal dissolution reaction which heats the electrolyte and causes lift. During times of low load, a smaller circulation rate is provided, primarily by means of the corrosion reaction which releases gas into the electrolyte and, hence, reduces the fluid density in the cells and again provides electrolyte lift. This maintenance of low circulation rate at no load conditions is a distinct advantage over prior art, where, in order to conserve power, the external pumping action is turned off. By maintaining this reduced ‘steady state’, circulation rate, the battery of the invention is in a state of readiness to return to full power under a minimized delay response as compared to batteries which must use some power to initiate the electrolyte flow by means of an external pump, or to build up H₂ gas pressure for electrolyte pumping.

Accordingly, the invention provides in one aspect, an electrochemical battery comprising a housing; an electrolyte within said housing; an anode within said electrolyte and said housing and having an anode surface upper portion and an anode surface lower portion; a cathode within said electrolyte and said housing and having a cathode surface upper portion and a cathode surface lower portion at an inter-electrode distance from said anode to operably provide upward laminar flow of said electrolyte from said anode and cathode lower portions to said anode and cathode upper portions; recycle downcomer channel means for effecting and allowing of downward gravity flow of an upper portion of said electrolyte from said anode and cathode surface upper portions to provide a recycled lower portion of said electrolyte for recycle to said anode and cathode.

The term “electrolyte” herein, refers to aqueous electrolytic solution.

The downcomer channel in one embodiment may be contained within the housing wherein, for example, said housing has vertical wall means comprising a first vertical wall and a second vertical wall opposite said first vertical wall; said downcomer channel means comprises a first vertical inner wall parallel and adjacent to at a distance from said first vertical wall to define therewith a first recycle downcomer channel. A similar downcomer channel assembly may, preferably, be provided as a second vertical inner wall parallel and adjacent to at a distance from said second vertical wall to define therewith a second recycle downcomer channel.

In an alternative embodiment, the downcomer channel means is external of the housing and constituted, for example, as a vertical tube, pipe, conduit or the like in communication with the upper and lower portions of the electrolyte.

It will be readily understood by the skilled person from the aforesaid description, that an embodiment having a downcomer channel of suitable dimensions and not having a distinct vertical inner wall member parallel to the housing outer wall, is within the invention as hereinbefore defined. Provided that the electrolyte flow paths are as hereinbefore described and result from suitable cell inter-electrode distances and electrode plate height and widths to produce electrolyte laminar upward flow which subsequently passes down adjacent electrode edges, the promise of the invention is met.

The housing in one embodiment comprises a bottom portion and a lower side portion which define a lower conduit within said housing below said anode and cathode lower portions, which lower conduit receives said recycled lower portion of said electrolyte.

By the term “lower conduit” in this specification is meant a passage, space, chamber and the like where the electrolyte contained therein is, operably, when under full, or low load, continually, flowing and the like as to be not stagnant to allow of settling of particulate matter in the conduit.

To enhance even distribution of the electrolyte recycled across the anode and cathode surface lower portions, the lower conduit further comprises a baffle plate means having portions defining a plurality of apertures to effect distribution of the recycled lower portion of electrolyte across the lower conduit extending within the lower conduit from the vertical wall means.

The battery of the present invention relies on the production of laminar flow of the electrolyte between the anode and cathodes during operation under load caused by release of gas bubbles and electrolyte temperature increase due to evolution of heat into the electrolyte to cause convection flow of the heated electrolyte from the lower anode surface to the upper anode surface.

The rising of the gas bubbles causes upward lift of the electrolyte. At the top of the electrolyte within the housing, the gas bubbles escape from the liquid while the liquid is essentially pushed the distance of the electrode widths to either side of the housing, where an amount of cooling of the electrolyte is effected. Both of the effects of reduced bubble concentration in and lowering of temperature of the electrolyte at the housing walls results in an increase in electrolyte density to cause the electrolyte in this channel region to fall under gravity to the lower regions of the battery. Thus a recycling circulation path is established.

Thus, judicious selection of the inter anode-cathode distance of, for example 1-5 mm, encourages upward laminar electrolyte flow between the electrodes, facile removal of gas bubbles from the top of the electrolyte and sufficient cooling of the “de-gassed” electrolyte to allow of a suitable temperature gradient to be established in the downcomer channel region, to result in the gravity-led recycle process.

The aforesaid principles and advantages are also manifested in batteries according to the invention in embodiments wherein the downcomer channel is external of the housing.

The electrolyte may be initially added, replenished or removed through an inlet/outlet manifold.

The invention most preferably provides a battery stack comprising a plurality of batteries hereinabove defined, electrically connected in series or parallel, and preferably chemically connected in parallel.

The battery according to the invention has applicability as a small footprint, and compact, relatively low life-cycle cost, electric power source for residential, commercial, industrial and vehicular use.

Although, optional the batteries of the invention do not require circulating pumps or other power-consuming equipment, and rely on thermal- and gas-induced hydrodynamic lift with return gravity recycle.

The anode in the form of a plate, sheet or the like, is, preferably, interspersed between and adjacent a pair of gas diffusion cathodes. The inter-electrode distance may be of any suitable size to provide the desired laminar upward flow. Typically, the spacing is selected from 1-5 mm, preferably about 2-3 mm.

The width of the electrode plates is so selected as to allow of suitable, essentially, horizontal movement of electrolyte at the upper portions of the electrodes to at least one of the two outer edges of the electrodes, i.e. to the downcomer region(s). The height of the electrodes within the housing may be as desired, since increasing the electrode height over the aforesaid inter-electrode distance merely increases the bubble concentration and temperature gradient.

An inter-electrode electrolyte laminar flow rate of about 0.15 cm/sec in the inter-electrode operation zone and about 0.7-1 cm/sec in the downcomer channel is generally attained when a single battery of the invention is producing about 20 amps, wherein within the housing a plurality of anodes and cathodes having active surface area dimensions of 20 cm in width, 10 cm in height and 2 mm thick are disposed with an inter-electrode distance of 2 mm.

The housing is generally formed of a non-conducting plastics material such as, for example, polyethylene, polypropylene, or more preferably, ABS or PVC polymeric material.

Any recycled lower electrolyte distribution means to provide uniform electrolyte concentration to the electrodes' lower surfaces, may be chosen.

In preferred embodiments, the lower conduit receiving the recycled electrolyte from the downcomer chamber may communicate directly with a larger electrolyte settling chamber to provide for settling of the particulate sodium aluminate, Na Al (OH)₄, matter. Alternatively, the decreasing velocity flow gradient of the recycled electrolyte through a preferred suitably-shaped conduit, as hereinafter described, allows of partial settling of the particulate matter in a connecting manifold for subsequent removal.

The anode may be formed of any metal or alloy, that is typically utilized with metal-gas diffusion cathodes. Such anodic materials may be selected from aluminum, magnesium, zinc and alloys thereof.

The metal-gas diffusion cathode may be one selected from the prior art. The preferred embodiments comprise a nickel-air or nickel-oxygen diffusion cathode.

Typical electrolytes of use in the battery according to the invention when an aluminum anode is used with the production of hydrogen, is a alkali metal base selected from KOH and NaOH or salts thereof, at a concentration of 4 mol/liter electrolyte.

### BRIEF DESCRIPTION OF THE DRAWINGS

In order that the invention may be better understood, preferred embodiments will now be described, by way of example only, with reference to the accompanying drawings, wherein

FIG. 1 is a perspective view, partly cut-away, of a battery having an inner housing downcomer channel according to the invention;

FIG. 2 is a diagrammatic, vertical, cross-sectional end view of a housing of use in a battery according to the invention showing electrolyte flow paths;

FIG. 2A is the view of FIG. 2 wherein the downcomer channel has been sealed to show non-inventive electrolyte flow paths;

FIG. 3 is a perspective view, partly cut-away, of a battery having a downcomer channel external of the housing, according to the invention;

FIG. 4 is a perspective view of a battery stack, according to the invention; and wherein the same numerals denote like parts;

FIG. 5 is a diagrammatic representation of a hybrid double external downcomer channel cell, according to the invention;

FIG. 6 represents graphs showing the stationary voltage-ampere and power-ampere characteristics at two different temperatures of a cell according to the invention;

FIG. 7 represents graphs showing the stationary voltage-ampere and power-ampere characteristics at a constant temperature;

FIG. 8 shows the discharge characteristics of aluminum anode nickel-air diffusion cathode prior art cell and cells according to the invention;

FIG. 9 is a graph of the electrolyte circulation rate over time through a cell according to the invention; and

FIG. 10 shows graphs of corrosion current density against electrolyte temperature at various cell current densities for a cell according to the invention.

### DETAILED DESCRIPTION OF PREFERRED EMBODIMENTS

The basic electrochemical process of an air-metal battery can be explained using the aluminum-air battery as an example.

Aqueous solutions of alkali and salts are utilized as electrolytes in aluminum-air current sources. The following electrochemical reactions occur in the alkali solutions:

Anode dissipation of aluminum at the anode (negative electrode) according to equations (1) and/or (2):

Al+4OH⁻→AlO₂⁻+2H₂O+3e (1)

or

Al+4OH⁻→Al(OH)₄⁻+3e (2)

The cathode reduction of the oxygen at the positive electrode (gas-diffusion cathode) according to equation (3):

O₂+2H₂O+4e⇄4OH⁻ (3)

Inasmuch as aluminum is thermodynamically unstable in water, the electrochemical corrosion takes place at the anode that is denoted by the same equations (1) and (2) and the conjugate process is the cathodic production of hydrogen from water at the cathode:

2H₂O+2e→H₂+2OH⁻ (4)

Summing up the current generation and the corrosion reaction is described by respective equations (5) and (6) below:

4Al+3O₂+6H₂O+4NaOH→4NaAl(OH)₄ (current generation) (5)

2Al+6H₂O+2NaOH→2NaAl(OH)₄+3H₂ ↑ (corrosion) (6)

The solubility of the reaction product is limited. Therefore, when the solubility limit is reached, a decomposition process of the solute begins, according to reaction (7):

NaAl(OH)₄→NaOH+Al(OH)₃ (7)

As a result of which the final reaction product is formed: e.g. crystalline aluminum hydroxide. This simplified scheme can be represented as a summation of equations for the current formation process:

4Al+3O₂+6H₂O→4Al(OH)₃ (8)

and for the corrosion reaction:

2Al+6H₂O 2Al(OH)₃+3H₂ ↑ (9)

Although the reaction mechanism in neutral salt electrolytes differs from reaction mechanism in an alkali solution, the summarising processes are adequately represented by equations (8) and (9).

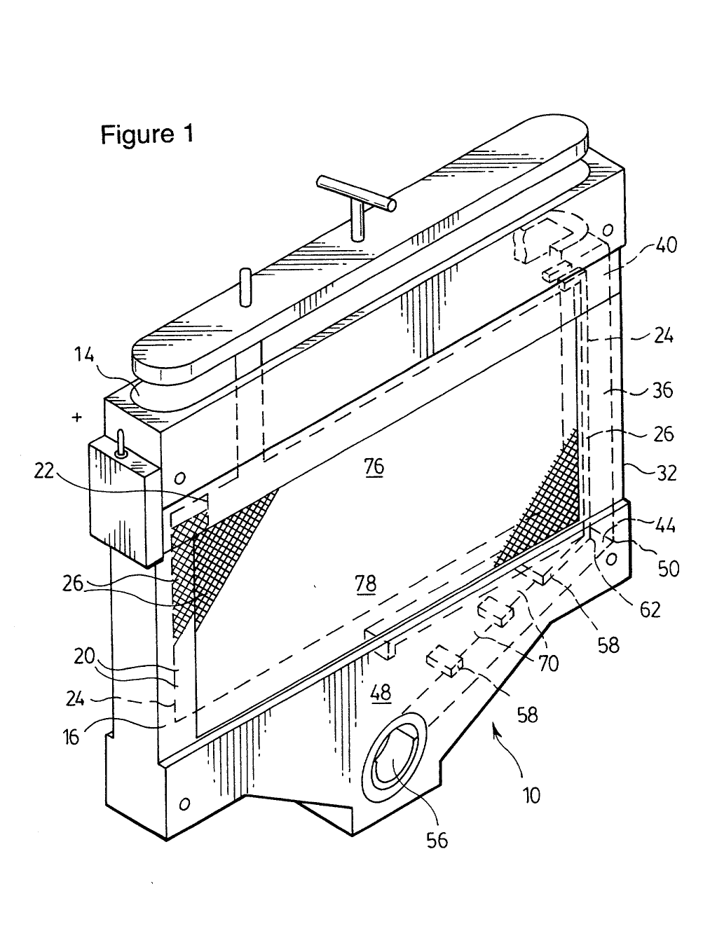

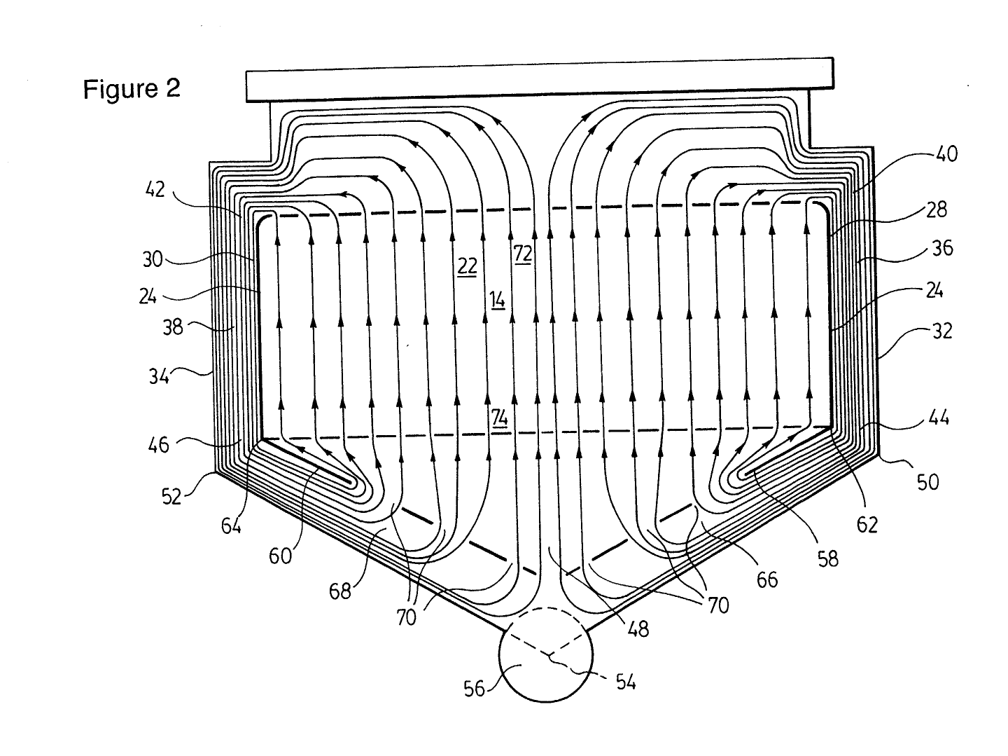

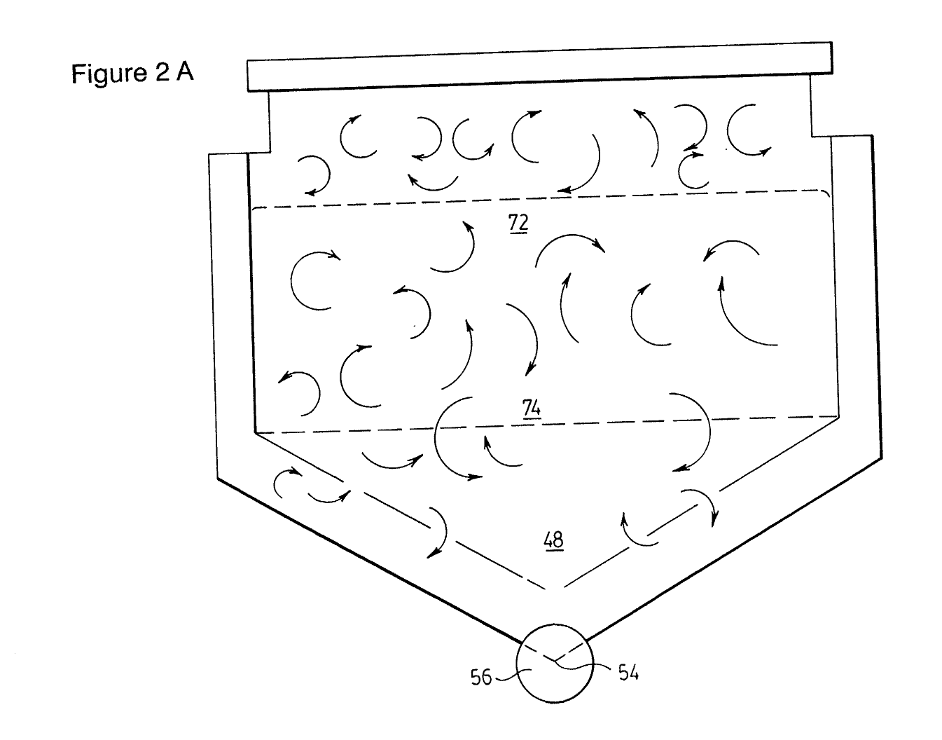

With reference to FIG. 1 and FIG. 2, these show generally as 10, a single cell battery having a rectangularly-shaped housing 12 formed of PVC polymeric material, of O.D. dimensions 20 cm width, 10 cm height and 2 cm thickness, and which defines an internal electrolyte chamber 14, essentially between front wall 16 and back wall 18.

Within chamber 14 is a pair of nickel-air diffusion cathode plates 20 and an aluminum alloy anode plate 22, at inter anode-cathode distances of 2 mm. Each of side vertical edges 24 of anode 22 and side vertical edges 26 of cathode 20 terminate at an housing inner vertical side wall 28 or 30. Each of inner side walls 28 and 30 define with each adjacent outer vertical wall 32 and 34, respectively, open-ended downcomer channels 36 and 38, respectively, of 1 cm×1 cm cross-section. Downcomer channels 36 and 38 have upper electrolyte inflow apertures 40 and 42, respectfully, and lower electrolyte outflow apertures 44 and 46, respectively.

Housing 12 at its lower portion, below anode 22 and cathode 20 defines an inverted isosceles triangle-shaped lower chamber 48 in communication at each of its side corners 50, 52 with each of downcomer lower outflow apertures 44 and 46, respectively. Inverted apex 54 of chamber 48 is formed with manifold 56.

Within chamber 48 are a pair of longitudinal baffle plates 58 and 60 extending from the bottom edges 62, 64 of inner vertical walls 28 and 30, respectively, parallel to the respective bottom sides of housing 12. Each of baffle plates 58 and 60 defines lower conduits 66 and 68, respectively, and has a plurality of apertures 70 to effect distribution of recycled electrolyte within chamber 48 from downcomer channels 36, 38, via conduits 62 and 64.

Anode plate 22 has an upper surface portion 72 and a lower surface portion 74. Similarly, each of cathode plates 20 has a surface upper portion 76 and a surface lower portion 78.

In operation, feed electrolyte is added to cell electrolyte chambers 14 and 48 through manifold 56. Under electrical demand (load) the electrolyte heats up by the exothermic anode reaction, which causes the electrolyte to rise from adjacent lower electrode surfaces e.g. 74 to adjacent upper electrode surfaces e.g. 72. In view of the relatively narrow inter-electrode gap of about 2 mm, the electrolyte upward flow is essentially laminar the full widths of electrode plates 20, 22. The arrows in FIG. 2 show the directions of electrolyte flows. In the embodiment shown in FIG. 1, rates of up to 5 cc/sec recycle electrolyte pass through each of downcomer channels 36 and 38 under gravity. Electrolyte cools within channels 36 and 38 to set up the recycle flows, with its attendant aforesaid advantages.

FIG. 2A illustrates the non-laminar flow of electrolyte between the electrodes by reason that recycle through a downcomer to set up recycle flows according to the practice of the invention cannot be achieved.

The circulation induced by downcomer channels according to the invention provides an additional benefit over the prior art shown in FIG. 2A. In the randomized flow pattern generated in the prior art, the solids produced by the electrochemical reaction are not swept from the electrolyte inter-electrode channels and tend to stick to the anode and cathode surfaces. This behaviour is also observed in cells wherein the downcomers are deliberately blocked. Removal of the anode and cathode plates show thick layers of solids adhering to both surfaces. The adherence of the solids to the surfaces increases the resistance of the cell by decreasing the free electrolyte near the electrode surfaces, by increasing the diffusion path for reactants requiring access to the surface and to reaction byproducts needing to leave the surface. Although not herein specifically measured, the presence of solids on the electrode surfaces causes a loss of voltage because of increase of electrolyte cell resistance and causes a loss of power because of the increased diffusional path at the electrode surface.

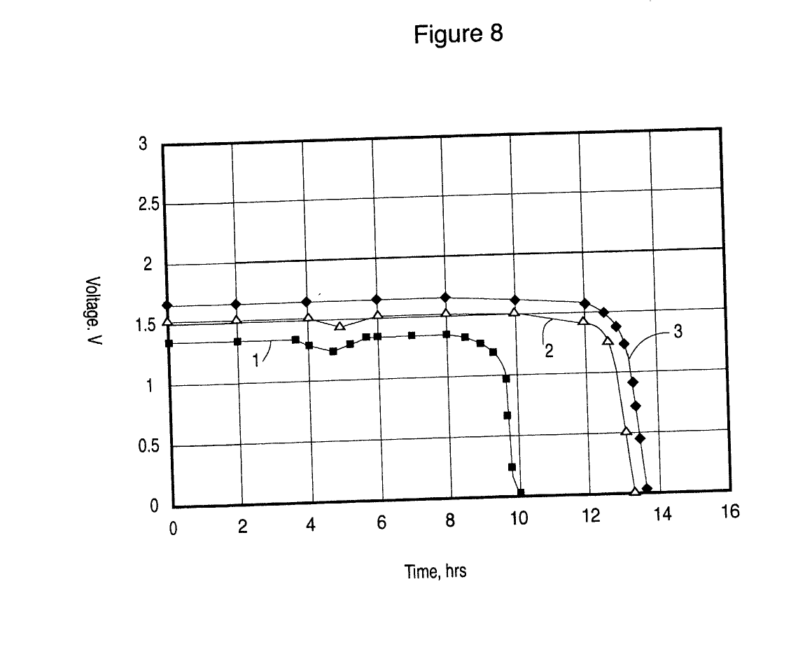

In contrast, the cells of the present invention do not suffer from these losses because the circulation induced by the downcomers is sufficient to sweep the solids from the surface of the anode where they are produced and prevents them from accumulating at the cathode surface. By moving the solids from the electrolyte between the electrodes quickly and efficiently to the top of the cell and, thence, to the downcomer channels and finally to the bottom of the cell 56 or 86 where separation occurs, cell performance is enhanced. This improved performance is clear from the results shown in FIG. 8 for curves 2 and 3, as compared to the prior art shown as curve 1.

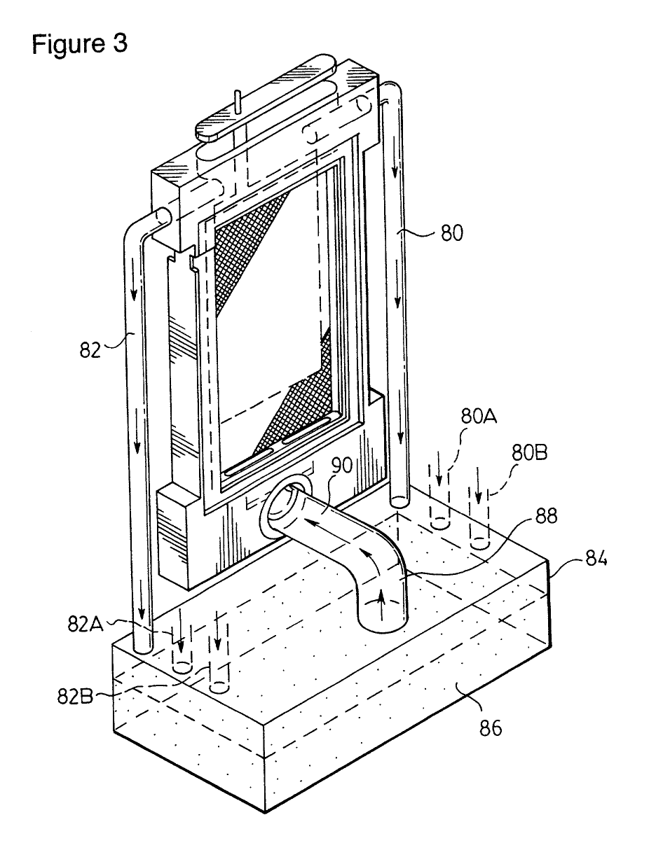

FIG. 3 shows an alternative embodiment wherein the inner downcomer channels 36 and 38, shown in FIGS. 1 and 2 are absent in favour of external downcomer channels 80 and 82. Channels 80 and 82 also feed into recycle electrolyte settling tank 84 wherein solid particulate matter 86 is allowed to settle, while supernatant electrolyte recycles back to the cell chambers though vertical conduit 88 and manifold 90. This embodiment allows of enhanced cooling of the downcomer electrolyte relative to the inner downcomer embodiment described with reference to FIGS. 1 and 2.

Also shown, in part, are respective downcomer channels 80A, 80B and 82A, 82B of two adjacent cells (not shown), communicating with the settling tank 84.

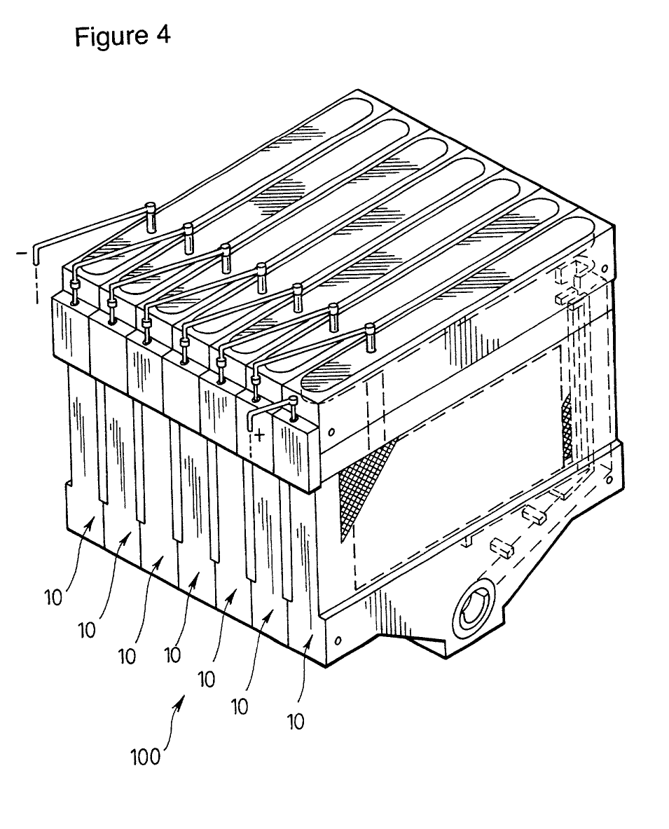

FIG. 4 shows a cell stack, generally as 100, comprising a plurality of cells 10 (seven in the embodiment shown) connected in parallel electrolyte flow relationship.

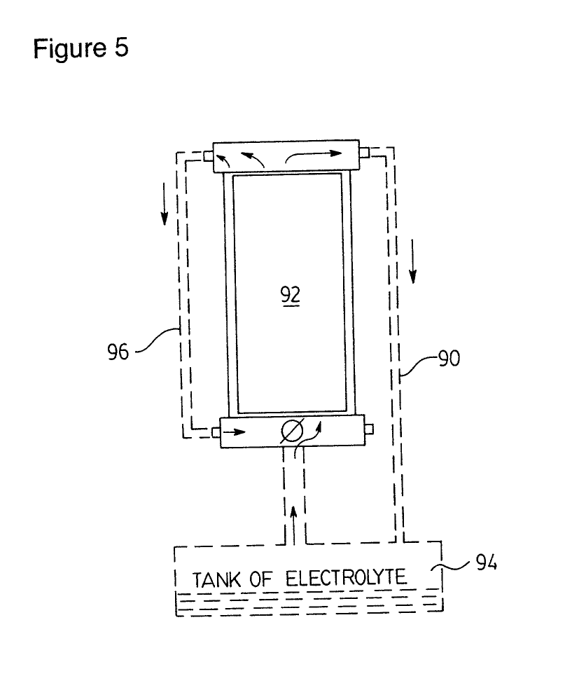

FIG. 5 is a hybrid combined double outer downcomer channel-containing cell, wherein the external channel 90 feeds a portion of recycled electrolyte to electrolyte chamber 92 via electrolyte settling tank 94, and external channel 96 feeds the remaining portion directly to the electrode lower surfaces.

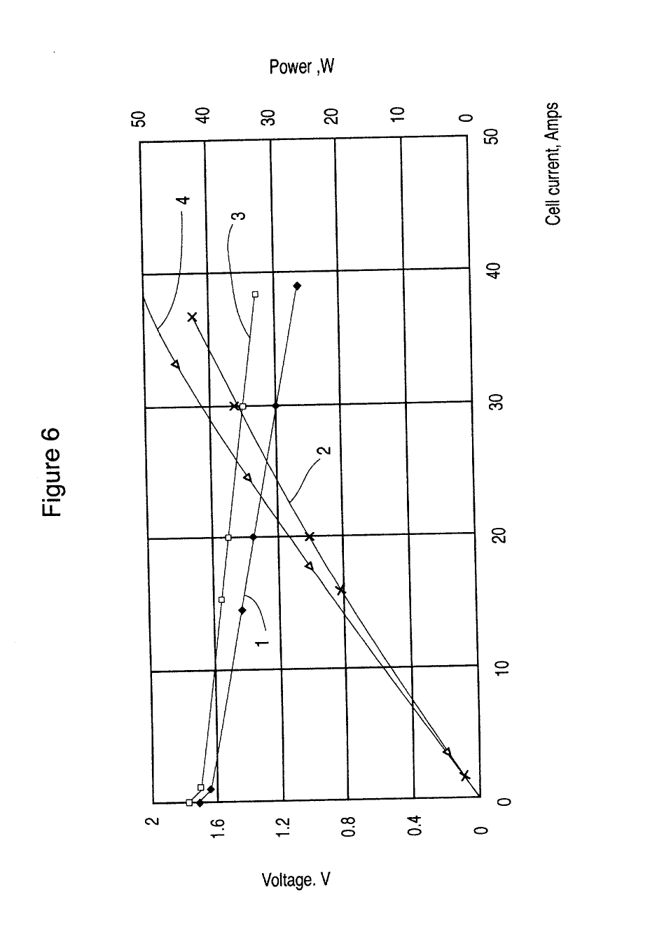

With reference to FIG. 6, the graph shows curves identified as follows.

Curves 1 and 3 represent volt-ampere characteristics, and curves 2 and 4 represent power-ampere characteristics at 23° C. and 40° C., respectively. The aforesaid characteristics were obtained by measuring cell voltage while ramping up the load current from 0 to 38 amps. FIG. 6 shows the high power and voltage that can be produced with an aluminum air battery using active downcomer channels and the circulation that is induced can be sustained even over a significant battery operating temperature range of 23°-40° C.

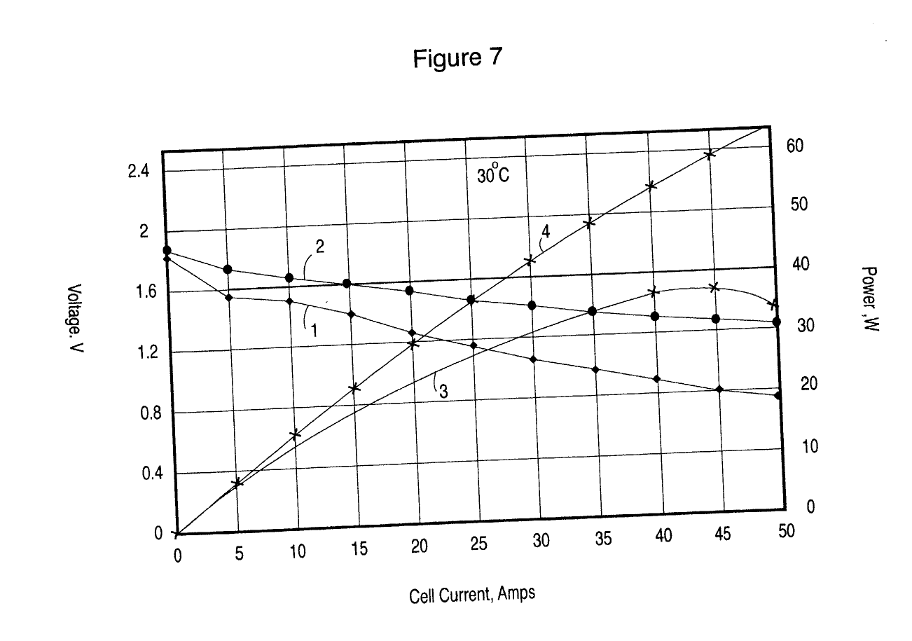

With reference to FIG. 7, the graphs show curves identified as follows.

Curves 1 and 3 represent stationary voltage-ampere and power-ampere characteristics, respectively, at 30° C. in a cell according to the invention, but modified with closed downcomer channels. Curves 2 and 4 represent the same graphs, respectively, wherein the cell has open, downcomer channels.

The characteristics were obtained by measuring cell voltage while ramping up the load current from 0 to 50 amps.

The results show the superior voltage and power output from the cell with downcomer recycle according to the invention.

With reference to FIG. 8, the curves represent discharge characteristics of aluminum anode-nickel air diffusion cathode cells, wherein line 1 is for a cell according to the prior art, and lines 2 and 3 for different cells according to the invention.

The cell voltages were measured at an electrolyte (20% w/w KOH) temperature of 25° C. and a current density of 50 mA/cm². Cells 2 and 3 with downcomer channels according to the invention allowed for full, unimpeded, laminar upward flow of electrolyte between the electrodes and maximum downcomer recycle flow.

It can be seen that better cell performance was achieved i.e. high maximum voltages of 1.6 v and 1.5 v over a total discharge time of about 13.5 hours for cells 2 and 3 than for prior art cell 1 which gave a maximum voltage of 1.4 v and total discharge time of 10 hours. This improvement is attributed to the natural circulation and combined thermo convection with the flow dynamics of hydrogen bubble evolution at the anode surface, which results in better mixing of the electrolyte solution. In the case of prior art, cell 1, the initial voltage drop reflects the detrimental effect of aluminum anion salt production, which subsequently causes the formation of solid particulate aluminum hydroxide between the electrodes and, thus, an increase in the electrolytic solution resistance and lowering of the cell voltage.

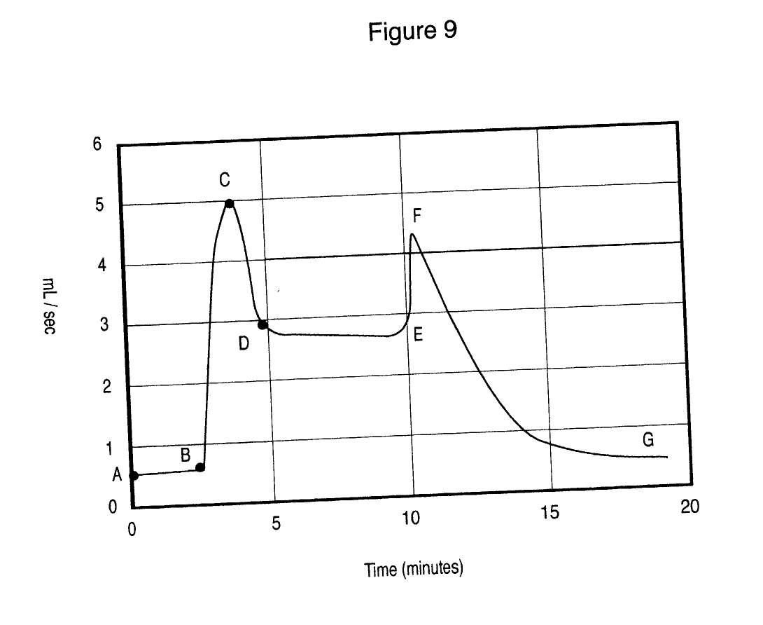

With reference to FIG. 9, the graph illustrates the change in the rate of electrolyte circulation as measured at downcomer channels 36, 38 of FIGS. 1 and 2. This rate was initially 0.6 mL/s from points A to B during which the anode was corroding freely under open circuit i.e. “no load” conditions at an ambient temperature of 20-23° C. and due primarily to hydrogen bubble generation. When a load was applied to the cell at point B, the onset of electrochemical reactions within the cell caused the temperature in the operation zone at the anode surface to increase. Temperature electrolyte convection flow combines with the flow of hydrogen bubbles generated by the corrosion reaction, to enhance the rate of natural circulation to a maximum value of 5 mL/sec at point C. At point C there are two causes of circulation, namely, foremost, temperature and, secondarily, hydrogen bubble generation. From point C to point D there is a transient temperature profile where the temperature gradient decreased approximately to a steady state value and hydrogen bubble generation becomes a non-significant driver of circulation in the cell. This was reflected by the circulation rate decreasing from 5 to 2.5 mL/sec from points C to D to a steady-state regime from points D to E. In this steady-state regime, the steady-state temperature was 36 to 40° C. and electrolyte circulation was promoted by both hydrogen evolution and a steady state temperature which caused the circulation rate to be virtually constant at 2.6 mL/sec from points D to E. When the load was disconnected at point E, a sudden increase in the rate of corrosion caused the circulation rate to increase up to 4.2 m/L/sec at point F primarily due to hydrogen bubble separation. As the temperature decreased from point F to G, the circulation decreased to its initial no-load value of 0.6 mL/sec, as hydrogen bubble generation returned to the initial low temperature value.

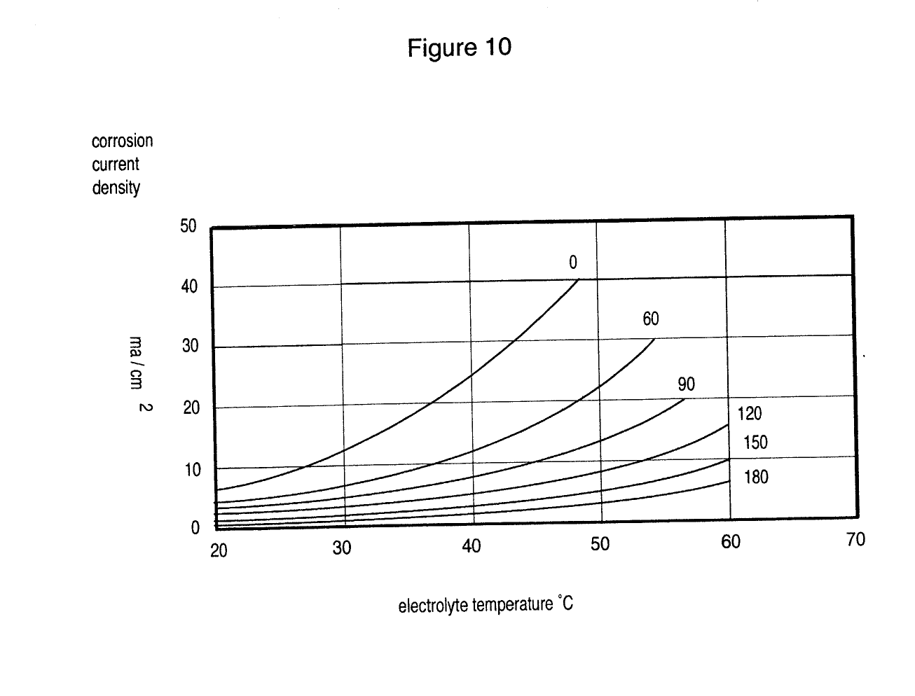

FIG. 10 shows that when the electrolyte temperature increases the corrosion current density increased exponentially. The uppermost curve with a cell current density of 0 mA/cm² exhibits the greatest corrosion current densities. At increasing cell current densities by the application of increasing load ranging from 60 mA/cm² to 180 mA/cm², the corrosion current density decreases. For example, the 60 mA/cm² curve is below the 0 mA/cm² curve and so on. The lowermost curve on FIG. 10 exhibits a current density of 180 mA/cm².

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. An electrochemical battery comprising
a housing;
an electrolyte within said housing;
an anode within said electrolyte and said housing and having an anode surface upper portion and an anode surface lower portion;
a cathode within said electrolyte and said housing and having a cathode surface upper portion and a cathode surface lower portion at an inter-electrode distance from said anode to operably provide upward laminar flow of said electrolyte from said anode and cathode lower portions to said anode and cathode upper portions;
recycle downcomer channel means for effecting and allowing of downward gravity flow of an upper portion of said electrolyte from said anode and cathode surface upper portions to provide a recycled lower portion of said electrolyte for recycle to said anode and cathode.

2. A battery as defined in claim 1 wherein said downcomer channel means is within said housing.

3. A battery as defined in claim 1 wherein said downcomer channel means is external of said housing.

4. A battery as defined in claim 1 wherein said lower portion of said electrolyte is at a lower temperature than said upper portion of said electrolyte.

5. A battery as defined in claim 1 wherein said housing has vertical wall means comprising a first vertical wall and a second vertical wall opposite said first vertical wall;
said downcomer channel means comprises a first vertical inner wall parallel and adjacent to at a distance from said first vertical wall to define therewith a first recycle downcomer channel.

6. A battery as defined in claim 5 wherein said downcomer channel means further comprises a second vertical inner wall parallel and adjacent to at a distance from said second vertical wall to define therewith a second recycle downcomer channel.

7. A battery as defined in claim 1 wherein said housing comprises a bottom portion and a lower side portion which define a lower conduit within said housing below said anode and cathode lower portions, which lower conduit receives said recycled lower portion of said electrolyte.

8. A battery as defined in claim 7 further comprising baffle plate means having portions defining a plurality of apertures to effect distribution of said recycled lower portion of electrolyte across said lower conduit extending within said lower conduit from said vertical wall means.

9. A battery as defined in claim 1 wherein said anode is formed of a metal selected from aluminum, zinc and magnesium, and alloys thereof.

10. A battery as defined in claim 1 wherein said cathode is a gas diffusion cathode.

11. A battery as defined in claim 7 further comprising an inlet/outlet electrolyte manifold in communication with said lower conduit.

12. A battery as defined in claim 1 having an inter-electrode distance selected from 1 to 5 mm.

13. A battery stack comprising a plurality of batteries as defined in claim 1.
